(19) United States
(12) Patent Application Publication
(10) Pub. No.: US 2023/0385894 A1
(43) Pub. Date: Nov. 30, 2023

(54) METHOD FOR ORDERING CUSTOMIZED INSOLE USING ARTIFICIAL INTELLIGENCE ALGORITHM

(71) Applicant: OOZOOTECH CO., LTD., Ansan-si (KR)

(72) Inventor: Min-Su HEO, Gimpo-si (KR)

(21) Appl. No.: 18/112,515

(22) Filed: Feb. 22, 2023

(30) Foreign Application Priority Data
May 26, 2022 (KR) 10-2022-0064552

(51) Int. Cl. G06Q 30/0601; G06N 3/045; G06N 3/0464; G06V 10/764; G06V 10/82; G06V 40/10; G06T 7/70

(52) U.S. Cl. CPC G06Q 30/0621; G06N 3/045; G06N 3/0464; G06V 10/764; G06V 10/82; G06V 40/10; G06T 7/70; G06T 2207/20081; G06T 2207/20084; G06T 2207/30196

(57) ABSTRACT

The present disclosure provides a method for ordering insole optimized to a customer in which a learning model classifying foot types from various human foot images is established by using an artificial intelligence algorithm, an image of a customer's rearfoot is read based on the learned model, and customized insole information corresponding to the foot type is provided to the customer.

### CROSS-REFERENCE TO RELATED APPLICATION

This application claims priority from and the benefit of Korean Patent Application No. 10-2022-0064552, filed on May 26, 2022, which is hereby incorporated by reference for all purposes as if fully set forth herein.

### BACKGROUND

### Field

One or more embodiments relate to a method for ordering customized insole using an artificial intelligence (AI) algorithm, and more particularly, to a method for ordering insole optimized to a customer in which a learning model classifying foot types from various human foot images is established by using an artificial intelligence algorithm, an image of a customer's rearfoot is read based on the learned model, and customized insole information corresponding to the foot type is provided to the customer.

### Discussion of the Background

When combining both feet, 52 large and small bones, numerous joints, tendons, ligaments, nerves, and blood vessels gather to play an important role in supporting and balancing the body. Abnormalities and deformations of the feet affect the entire skeletal system, including the knees, pelvis, waist, and neck.

An insole is a means for improving the fit of the shoe by being inserted inside a shoe to and mitigating shock generated during walking or exercise to protect the wearer's feet and relieve fatigue at the same time.

The insoles are as important as shoes, as they are called the second shoes. In some cases, the insoles that are initially included when purchasing the shoes do not fully reflect the state of the wearer's feet, and this is especially true when abnormalities or deformations of the feet occur.

Recently, the demand for functional insoles that make feet comfortable to maintain health is gradually increasing. The functional insoles are ready-made products that are mass-produced, so they have advantages over customized insoles in terms of price and purchase time. However, although the functional insoles are produced for the user's foot health, there is a limit in that it is difficult to satisfy all the user's foot states compared to customized insoles.

The customized insoles are more beneficial to foot health because they are manufactured by reflecting the user's foot state. In particular, people who experience foot abnormalities or deformations or foot diseases such as plantar fasciitis prefer the customized insoles. However, the customized insoles require a visit to the store, and since they are manufactured by hand, it is burdensome in terms of production time and cost.

Korean Patent Registration No. 10-1899064 discloses system and method for manufacturing a customized assembled insole through foot size measurement information using smart device.

The above information disclosed in this Background section is only for understanding of the background of the inventive concepts, and, therefore, it may contain information that does not constitute prior art.

### SUMMARY

An object of the present disclosure is to provide a customized insole in which a type and insole of foot optimized for a customer are selected by using an artificial intelligence algorithm, and which is optimized even through a simple system for online rather than visiting a store.

In order to achieve the object described above, a method for ordering customized insole using an artificial intelligence algorithm according to the present disclosure, the method includes
(a) a step of acquiring a plurality of rearfoot original images to build a learning model using an artificial intelligence algorithm;
(b) a step of detecting a rearfoot image where background and/or noise are removed from the obtained original rearfoot image;
(c) a step of calculating an inclination angle of the inner ankle, an inclination angle of the outer ankle, and an inclination angle of the lower leg bisection line from the detected rearfoot image data and the detected rearfoot image, and generating them as input data (input layer) of the learning model;
(d) a step of performing foot type learning for learning the input data (input layer) as output data (output layer) of the foot type using the artificial intelligence algorithm;
(e) a step of classifying the foot type for classifying the customer's foot type by analyzing the foot image transmitted from a customer terminal based on the artificial intelligence algorithm built in the foot type learning step;
(f) a step of transmitting insole information optimized for the classified foot type to the customer terminal; and
(g) a step of outputting order information from the customer terminal to a supplier terminal.

In one aspect, the artificial intelligence algorithm may include a deep neural network and a convolutional neural network, an inclination angle of the inner ankle, an inclination angle of the outer ankle, an inclination angle of the lower leg bisection line, and left and right area data of the heel divided to left and right by the lower leg bisection line may be learned using a deep neural network, and the rearfoot image may be learned using a convolutional neural network.

In one aspect, an angle of the inner ankle may be an angle of a straight line created by connecting the inner ankle calculated from the rearfoot image and an inner surface of the foot sole, and an angle of the outer ankle may be an angle of a straight line created by connecting the outer ankle calculated from the rearfoot image and an outer surface of the foot sole.

In one aspect, the lower leg bisection line may set the center point of the ankle that bisects the distance between the inner ankle and the outer ankle, and the center point of the leg that bisects both points where a radius and the leg contour line intersect by setting a predetermined radius based on the center point of the ankle, and may be formed by connecting the center point of the leg and the center point of the ankle to each other.

In one aspect, the foot type may include the following six types,
\textcircled{1} A-type: overall level 3 supinated type which is an uncompensated rearfoot varus and in which the forefoot is the highest level 3 forefoot valgus, and an arch height is level 3;
\textcircled{2} B-type: overall level 1 pronated type in which the rearfoot is rearfoot valgus, the forefoot is flexible forefoot valgus, and the arch height is level 1;
\textcircled{3} C-type: overall neutral (normal) type (P) in which the rearfoot is uncompensated varus, the forefoot is neutral, and the arch height is intermediate level 2;
\textcircled{4} D-type: overall level 2 pronated type in which the rearfoot is compensated varus, the forefoot is neutral, and the arch height is level 1;
\textcircled{5} E-type: overall level 2 supinated type in which the rearfoot is uncompensated varus, the forefoot is level 2 varus, and the arch height is level 2; and
\textcircled{6} F-type: overall level 3 pronated type in which the rearfoot is compensated rearfoot varus, the forefoot is varus, and the arch height is 0-level.

In one aspect, the rearfoot of the insole applied to the A-type may be formed higher on the lateral side than on the medial side by an inclination angle of 5 to 15 degrees, inn the forefoot, the second, third, fourth, and fifth calcaneal head receiving portions may be formed higher than the first calcaneal head receiving portion, the midfoot may be formed higher on the lateral side than on the medial side, and a calcaneus cuboid arch portion where the calcaneus and cuboid are combined may be formed of a level 3 high support portion.

In one aspect, the rearfoot of the insole applied to the B-type is formed higher on medial side than on the lateral side with a gentle inclination to prevent the foot from leaning inward (eversion), the midfoot may be formed of a plantar fascia groove for accommodating the inner plantar fascia to prevent excessive tension in the inner plantar fascia from occurring, the forefoot may be formed higher on the medial side than on the lateral side, the big toe portion may extend from the first calcaneal head (mortons extension) and is formed slightly high, and the lateral calcaneus cuboid arch portion may be formed of a level 1 low support portion.

In one aspect, the rearfoot of the insole applied to the C-type may be formed slightly higher on the medial side than on the lateral side with no inclination or a gentle inclination, the midfoot may be formed of a support portion to control the transverse arch, in the forefoot, the second, third, and fourth calcaneal head receiving portions may be formed slightly higher than the left and right peripheral portions, and the lateral calcaneus cuboid arch portion may be formed of a level 1 low support portion.

In one aspect, the rearfoot of the insole applied to the D-type may be formed higher on the medial side than on lateral side with a gentle inclination to prevent the foot from leaning inward (eversion), the midfoot may be formed of a plantar fascia groove for accommodating the inner plantar fascia to prevent excessive tension in the inner plantar fascia from occurring, the forefoot may be formed higher on the medial side than on the lateral side, and a big toe portion may be formed slightly high by extending from the first calcaneal head (mortons extension).

In one aspect, the rearfoot of the insole applied to the E-type may be formed higher on the lateral side than on the medial side at an inclination angle of 2 to 10°, the forefoot may be formed slightly higher on the medial side than on the lateral side, the midfoot may be formed of a plantar fascia groove for accommodating the inner plantar fascia to prevent excessive tension in the inner plantar fascia from occurring, and the calcaneus cuboid arch portion where the calcaneus and cuboid are combined may be formed of a two-level support portion.

In one aspect, the rearfoot of the insole applied to the F-type may be formed higher on the medial side than on the lateral side with an inclination to prevent the foot from leaning inward (eversion), the forefoot may be formed higher on the medial side than on the lateral side, the big toe portion may be formed slightly high by extending from the first calcaneal head (mortons extension), and the lateral calcaneus cuboid arch portion may be formed of a level 1 low support portion.

In one aspect, a pressure sensitive film that is colored by a pressure may be attached to the lower or upper surface of the insole, so that the pressure distribution applied to the insole when the customer uses the insole may be capable of being confirmed.

In one aspect, in method for ordering customized insole using an artificial intelligence algorithm, after step (g), may further include
(h) a step of transmitting colored pressure sensitive film image information to the supplier server, reading whether the foot type is suitable, and re-determining the foot type if it is determined to be unsuitable; and
(i) a step of re-learning the foot type using the artificial intelligence algorithm based on the re-determined foot type data.

The method for ordering a customized insole using an artificial intelligence algorithm according to the present disclosure is an off-the-shelf mass-produced product in advance, so it is advantageous in terms of cost and time compared to conventional customized insole, and is optimized to reflect the user's foot state, making it comparable in functionality. In addition, it is possible to purchase online without the need to visit a store, so it has the advantage of meeting the online age.

It is to be understood that both the foregoing general description and the following detailed description are exemplary illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary illustrative embodiments of the invention, and together with the description serve to explain the inventive concepts.

FIG. 1 shows a network relationship of components according to an example of the present disclosure;

FIG. 2 shows a block diagram of an insole ordering system optimized for customers according to an example of the present disclosure;

FIG. 3 shows “pronated”, “neutral” and “supinated” forms of the foot;

FIG. 4 shows foot images obtained by removing a background and noise from original foot images according to an example of the present disclosure;

FIG. 5 shows a calculation process of the lower leg bisection line according to an example of the present disclosure;

FIG. 6 is a diagram showing an AI model structure of output values (foot type) according to input values (inner ankle, outer ankle, angle of lower leg bisection line, left and right area data of the heel, and foot image) in a model structure according to an example of the present disclosure;

FIG. 7 shows learning results according to an artificial intelligence algorithm according to an example of the present disclosure;

FIG. 8 is a perspective view (a), a front view (b), a plan view (c), a sectional view (d), a bottom view (e), and a side view (f) of a ‘A-type’ insole according to an example of the present disclosure;

FIG. 9 is a perspective view (a), a front view (b), a plan view (c), a sectional view (d), and a bottom view (e) of a ‘B-type’ insole according to an example of the present disclosure;

FIG. 10 is a perspective view (a), a front view (b), a plan view (c), a sectional view (d), and a bottom view (e) of a ‘C-type’ insole according to an example of the present disclosure;

FIG. 11 is a perspective view (a), a front view (b), a plan view (c), a sectional view (d), and a bottom view (e) of a ‘D-type’ insole according to an example of the present disclosure

FIG. 12 is a perspective view (a), a front view (b), a plan view (c), a sectional view (d), and a bottom view (e) of an ‘E-type’ insole according to an example of the present disclosure;

FIG. 13 is a perspective view (a), a front view (b), a plan view (c), a sectional view (d), and a bottom view (e) of a ‘F-type’ insole according to an example of the present disclosure; and

FIG. 14 shows an insole to which a pressure sensitive film is attached according to an example of the present disclosure, and shows (a) pressure sensitive film attached, (b) normal, (c) abnormal as a supinated state, and (d) abnormal as a pronated state.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

The following terms used in the present disclosure are based on orthopedic expressions and mechanisms related to the foot.

In the present disclosure, the expression “rearfoot varus” refers to a state where a point at which extensions of the calcaneal bisection line and the lower leg bisection line meet when viewed from the heel spreads outward (or distal) from a center line of the body.

In the present disclosure, the expression “rearfoot valgus” refers to a state where a point at which the extensions of the calcaneal bisection line and the lower leg bisection line meet when viewed from the heel gathers inward (or proximal) from the center line of the body.

In the present disclosure, the expression “forefoot varus” refers to a state where the big toe (or first calcaneal head) side is lifted relatively higher than the little toe (or fifth calcaneal head) side.

In the present disclosure, the expression “forefoot valgus” refers to a state where the little toe (or fifth calcaneal head) side is lifted relatively higher than the big toe (or first calcaneal head) side.

In the present disclosure, the expression “supinated” refers to a state of a three-dimensional motion state in which the foot collapses or leans in an outward (or distal) direction based on the center line of the body, and usually occurs due to inversion.

In the present disclosure, the expression “pronated” refers to a state of a three-dimensional motion state in which the foot collapses or leans in an inward (or proximal) direction based on the center line of the body, and usually occurs due to eversion.

In the present disclosure, ‘level’ represents the degree of orthopedic symptoms of the foot, and is classified into 0, 1, 2, and 3 levels in the present disclosure. Level 3 refers to a serious state, level 2 refers to a moderate state, level 1 refers to a relatively weak state, and level 0 refers to a normal state.

The method for ordering customized insole using an artificial intelligence algorithm according to the present disclosure includes
(a) a step of acquiring a plurality of rearfoot original images to build a learning model using an artificial intelligence algorithm;
(b) a step of detecting a rearfoot image where background and/or noise are removed from the obtained original rearfoot image;
(c) a step of calculating an inclination angle of the inner ankle, an inclination angle of the outer ankle, and an inclination angle of the lower leg bisection line from the detected rearfoot image data and the detected rearfoot image, and generating them as input data (input layer) of the learning model;
(d) a step of performing foot type learning for learning the input data (input layer) as output data (output layer) of the foot type using the artificial intelligence algorithm;
(e) a step of classifying the foot type for classifying the customer's foot type by analyzing the foot image transmitted from a customer terminal based on the artificial intelligence algorithm built in the foot type learning step;
(f) a step of transmitting insole information optimized for the classified foot type to the customer terminal; and
(g) a step of outputting order information from the customer terminal to a supplier terminal.

In one aspect, in the step (c), left and right area data of the heel divided to left and right by the lower leg bisection line may be further included as the input data of the learning model.

An online insole ordering system according to preferred exemplary examples of the present disclosure will be described in detail with reference to the accompanying drawings.

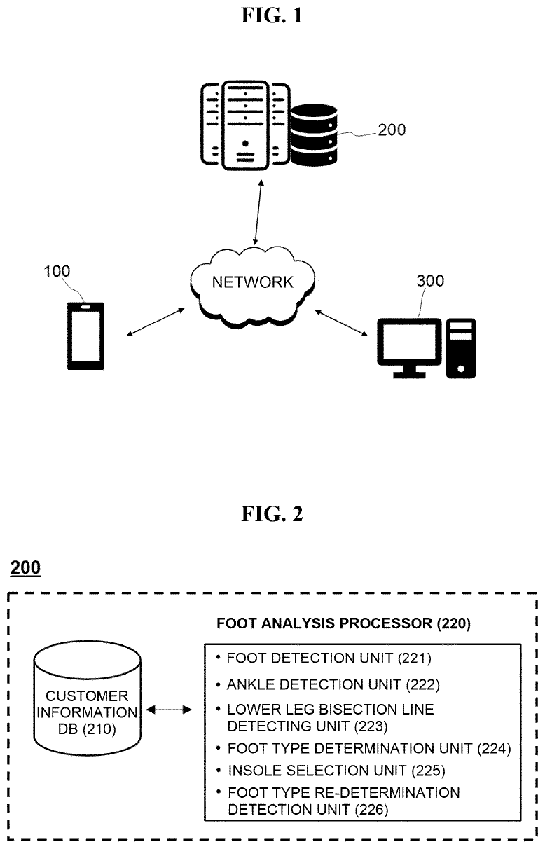

FIG. 1 shows a network relationship of components according to an example of the present disclosure.

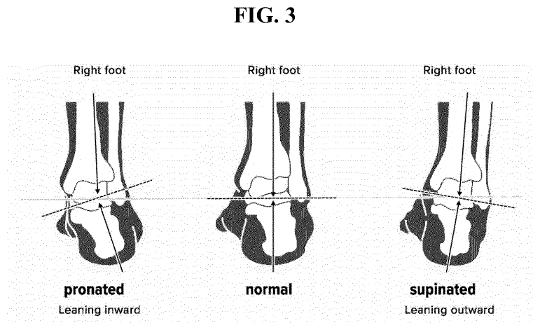

FIG. 2 shows a block diagram of an insole ordering system optimized for customers according to an example of the present disclosure.

As shown in FIG. 1, the insole ordering system of the present disclosure includes a customer terminal 100 used by the customer, a supplier terminal 300 used by the supplier, and a supplier terminal 200 that determines the customer's foot type by analyzing foot image information provided by the customer, and transmits insole information optimized for the foot type to the customer terminal. The customer terminal 100, the supplier terminal 200, and the supplier terminal 300 are directly or indirectly connected to each other through a network such as the Internet or wireless communication.

First, the customer terminal 100 may be any device capable of display, data storage, and communication, such as a smartphone, tablet, or PC computer.

The customer terminal 100 may be connected to the supplier terminal 200 by installing a series of applications provided by the supplier, or access the website of the supplier terminal 200 without a separate application.

Customer information may be input on the application or website of the customer terminal 100 and transmitted to the supplier terminal 200. The customer information includes the customer's name, address, and contact information, and if necessary, may include gender, age, weight, height, foot size, or shoe size, and the like. It may be stored in the supplier terminal 200 through a customer authentication procedure, a member registration procedure, and the like.

If the customer terminal 100 is a smartphone or tablet, since a photographing module (camera function) is basically built-in, foot image information may be directly generated through the photographing module, and a foot image previously photographed in another device may be stored in the customer terminal (e.g., PC computer).

The foot image information photographed or stored in the customer terminal 100 is transmitted to the supplier terminal 200.

The foot image information may be a photograph (2D image) or a 3D image which is obtained by photographing the customer's foot (hereinafter referred to as an original image). The 3D image may be created using a 3D generating program (or application) provided by the supplier or a separate 3D generating application or program.

The foot image information basically includes a rearfoot image, and if necessary, may further include a side image and a sole image of the foot.

The rearfoot image is an image photographed from the rear toward the heel, and includes a lower leg (calf) portion.

The side image of the foot may be an image obtained by photographing of a medial side of the foot, that is, an inner arch of the foot and a height portion of the instep. The height, width, inclination shape, and the like of the foot arch and instep may be used to determine the foot type described later.

In the sole image, for example, specific information such as calluses may be used to determine the foot type described later.

The foot image is sensitive to photographing states. For example, the shape of the foot appears very diverse depending on the up and down, and left and right photographing angles, and the photographing height, and the chromaticity, contrast, and the like vary according to the lighting conditions. Therefore, it is possible to present a guide (manual) on photographing conditions and photographing methods for optimal image creation to the customer's terminal. On the other hand, in the case of smart phones and tablets, the photographing modules are provided on front and rear surfaces. The rear photographing module is the same as a subject, but in the case of the front photographing module, the subject may be set to be reverse left and right. Accordingly, guidance on a left-right reversal method or the like with the original image may be presented.

The supplier terminal 200 analyzes the foot image using a series of artificial intelligence algorithms for the foot image transmitted from the customer terminal 100 to determine the foot type, and then selects insole information of a type suitable for the foot type, and transmits the insole information to the customer terminal 100.

The supplier terminal 200 includes a customer information database 210 for storing customer information, and a foot analysis processor 220 for analyzing the customer's foot image and determining the foot type.

The foot analysis processor 220 includes an artificial intelligence algorithm to learn and determine the foot type from the rearfoot original image. In one aspect, the artificial intelligence algorithm may be a neural network algorithm. The neural network algorithm may be a deep neural network (DNN) or a convolutional neural network (CNN), and may include both the deep neural network and the convolutional neural network. The artificial intelligence algorithm may be a supervised learning model based on deep learning. The artificial intelligence algorithm may preferably be a supervised learning algorithm that is learned in a method in which input data (input layer) and output data (output layer) are given in advance.

A learning method for deriving a foot type according to the foot image according to the present disclosure is as follows.

First, a foot expert establishes in advance the foot type to be classified in the learning model based on orthopedic clinical data.

In podiatric orthopedics, one of the criterion for determining the foot type is a relationship between the lower leg bisection line and the calcaneal bisection line from the foot image. The calcaneus is the heel bone, and the calcaneus bisection line is the center line that bisects the calcaneus vertically. As shown in FIG. 3, according to the inclination direction and angle of the calcaneus bisection line, it is one of the main criteria for determining whether the customer's feet are orthopedically “pronated”, “neutral”, or “supinated” type, and the degree thereof is “mild,” “moderate,” or “severe,” and the like.

In one aspect of the present disclosure, foot types are determined based on 6 types, but these type classifications are only optimal based on clinical data acquired by the present inventor, and are not limited to the 6 types described below, and the foot types may be added or subtracted as needed.

In the present disclosure, the six foot types in order are A-type (S+++), B-type (P+), C-type (P), D-type (P++), E-type (S++), and F-type (P+++).

In the present disclosure, the level is classified into 0, 1, 2, and 3 levels according to the degree, and level 3 indicates the most severe in degree, level 2 relatively severe in degree, and level 1 relatively weak in degree.

\textcircled{1} A-type: overall level 3 supinated type (S+++) which is an inversion type in which the foot leans severely outward, the rearfoot is uncompensated rearfoot varus, the forefoot is the highest level 3 forefoot valgus, and the arch height is level 3;

\textcircled{2} B-type: overall level 1 pronated type (P+) in which the rearfoot is rearfoot valgus, the forefoot is flexible forefoot valgus, and the arch height is level 1;

\textcircled{3} C-type: overall neutral (normal) type (P) in which the rearfoot is uncompensated varus, the forefoot is neutral, and the arch height is intermediate level 2;

\textcircled{4} D-type: overall level 2 pronated type (P++) in which the rearfoot is compensated varus, the forefoot is neutral, and the arch height is level 1;

\textcircled{5} E-type: overall level 2 supinated type (S++) in which the rearfoot is uncompensated varus, the forefoot is level 2 varus, and the arch height is level 2; and

\textcircled{6} F-type: overall level 3 pronated type (P+++) in which the rearfoot is compensated rearfoot varus, the forefoot is varus, and the arch height is 0-level.

If it is difficult to classify into the above 6 foot types, a Cnp type (classification not possible) may be further added to the classification, and if the foot type is severe enough to make it difficult to apply the insole of the present disclosure, a CwP type (consult with doctor, doctor consulting) may be further added to the classification.

In the present disclosure, a model combining a deep neural network model and a convolutional neural network model may be used as the learning model.

A large number of foot original images are acquired for modeling learning of the present disclosure.

Each of the acquired images is labeled with a serial number, and the expert visually analyzes each original image to select from the eight foot types and label a result value according to each image.

The foot analysis processor 220 of the present disclosure mechanically extracts a foot image from which a background is removed from the original image and input data (input layer) from the foot image. The input data includes the inclination angle of the inner ankle and the inclination angle of the outer ankle, and if necessary, area data (left and right area ratio) of the heel may be added to the input data (input layer). The labeled input data are calculated through the neural network algorithm of the foot analysis processor 220, and the foot type is derived as a result value thereof. At the beginning of learning, the result (foot type) output by the foot analysis processor 220 shows a large error value (high loss) compared to the result (foot type) classified by the expert, but through repeated learning, gradually converges (foot type matching) on the foot type classified by the expert, and thereby the neural network algorithm of the present disclosure is established.

In order to accurately extract the input data of the artificial intelligence algorithm, unnecessary backgrounds must be removed from the foot original image.

The foot analysis processor 220 includes a foot detection unit 221 that removes unnecessary background and/or noise from the original foot image and detects only the foot image.

In one aspect of the present disclosure, as a method for removing the background from the original image, salient object detection (SOD) technology may be used. The SOD technology is a method for detecting an object considered important in an image, and segments only important foreground objects from the background. The SOD technology predicts a saliency map that expresses the probability that the salient object belongs to each pixel in the image as an intensity value. The saliency map is attribution means for creating a gradient by calculating the gradient for the input image of a prediction class logit. By observing the saliency map, it is possible to visually confirm which part of the image the specific prediction result of the convolution neural network (CNN) was attributed to. Specifically, it is possible to extract only the outline area of the foot in the image through regression analysis.

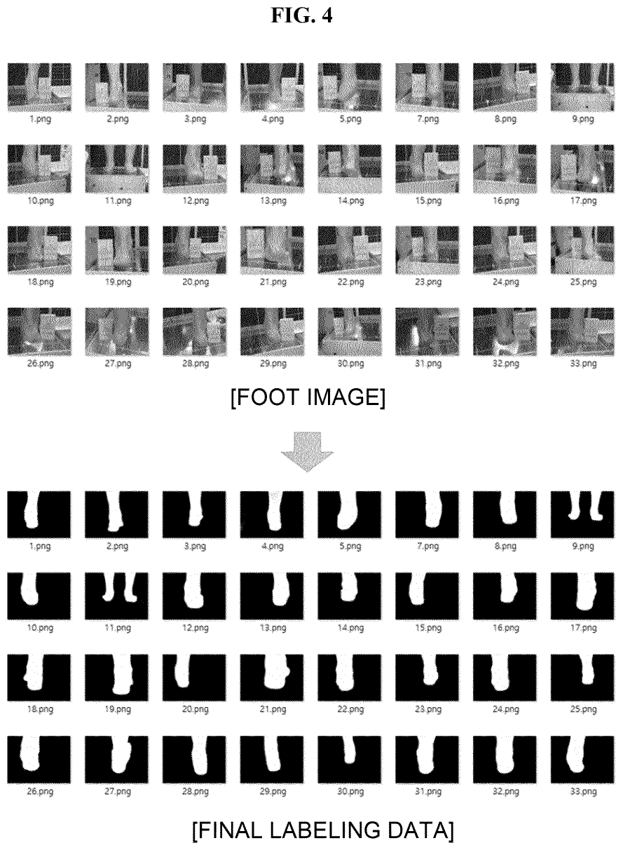

FIG. 4 shows images obtained by removing the background from original foot images using the SOD technology. As shown in FIG. 4, an error may occur in obtaining desired input data or an unnecessary portion, that is, noise, may occur in the foot image from which the background is removed. In the original image, such background and noise may be removed by using a background separation AI model or the like.

In one aspect, an image from which background or noise has been removed may be converted into a black and white image using a grayscale method. Thereafter, in one aspect, the grayscale image may be converted into a two-color image having only black and white by converting the grayscale image into a white image through a threshold, for example, binary threshold process. Then, the outline and its coordinates are extracted from the boundary between black and white, for example, by extracting approximate polygon. The method for extracting the outline is an example, and the method for extracting the outline is not limited thereto, and other known methods may be used.

The above background, noise-removed rearfoot image, its grayscale image, or binary image data may be used to extract input data (independent variable) from the artificial intelligence model, preferably the convolutional neural network.

The foot analysis processor 220 automatically extracts input data necessary for the neural network model of the present disclosure from the foot image from which the background is removed. From the rearfoot image, the inclination angle of the inner ankle, the inclination angle of the outer ankle, the inclination angle of the lower leg bisection line, and the left and right area data of the heel segmented in left and right by the lower leg bisection line may be calculated, and the data may be used as the input data (independent variable) in the artificial intelligence model, preferably in the deep neural network.

The input data of the present disclosure includes the inclination angle of the inner ankle, the inclination angle of the outer ankle, and the inclination angle of the lower leg bisection line.

The inner ankle is a portion that protrudes from the inside of the foot, and the outer ankle is a portion that protrudes from the outside of the foot.

The foot analysis processor 220 includes an ankle detection unit 222 that detects coordinates of the inner ankle and the outer ankle.

In the foot image of the present disclosure, the coordinate values of the inner ankle and the coordinate values of the outer ankle may be acquired by comprehensively reflecting, for example, coordinate deviation of the extracted outline, ankle detection, region of interest (ROI) setting, foot inclination, etc. For the inclination angle of the inner ankle, a series of virtual lines connecting the coordinate values of the distal end of the inner ankle and the coordinate values of the outline near the inside of the sole of the foot are set, and then the inclination angle with the highest angle among them may be used as the input data. For the inclination angle of the outer ankle, a series of virtual lines connecting the coordinate values of the distal end of the outer ankle and the coordinate values of the outline near the outside of the sole of the foot are set, and the inclination with the highest angle among them may be used as the input data.

The foot analysis processor 220 includes a lower leg bisection line detecting unit 223 that detects the lower leg bisection line.

The lower leg bisection line refers to a center line that left-right symmetrically divides the lower leg, that is, the calf above the ankle, in foot orthopedics.

In the present disclosure, the lower leg bisection line may be calculated without substantial error.

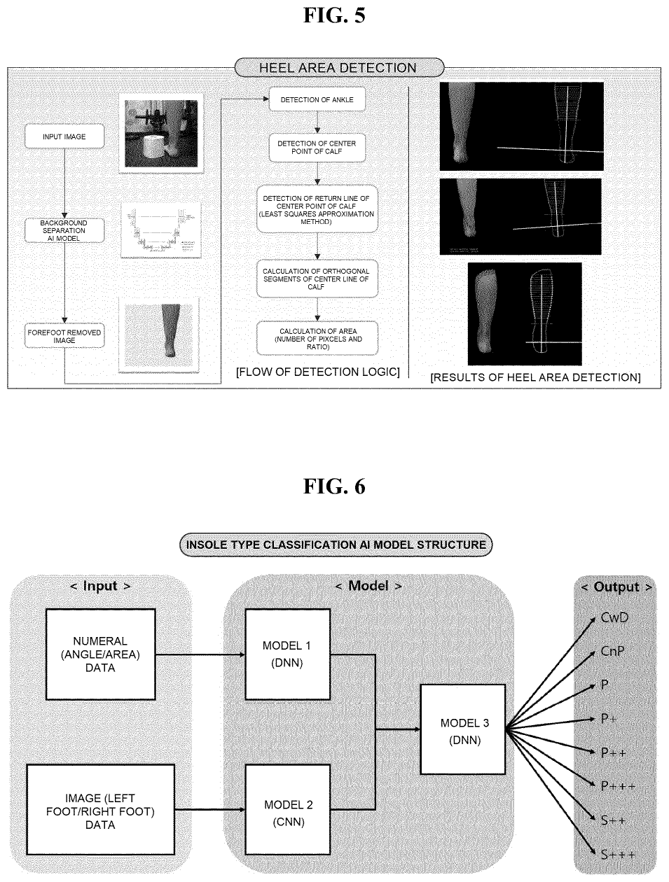

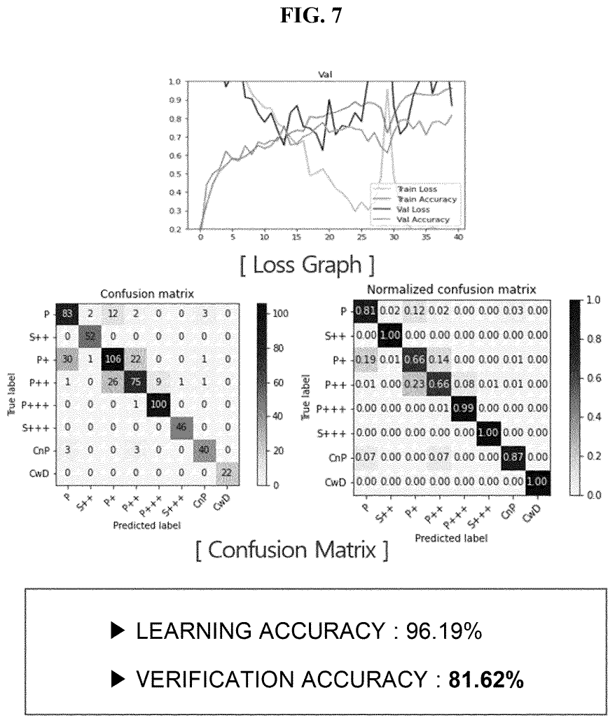

FIG. 5 is a preferred example of calculating the lower leg bisection line (calf center line).

As shown in FIG. 5, a series of center points are set from both coordinates where a plurality of horizontal lines (horizontal lines) generated by multi-dividing a portion corresponding to the lower leg (calf) in the lower leg (calf) foot image at a certain height and the outline of the lower leg (calf) meet, and the linear regression method and the least squares approximation method for the center points are used to detect the lower leg bisection line in the form of a straight line. The detected lower leg bisection line has a form close to vertical on the foot image, and the angle of the lower leg bisection line is used as one of the input data in the algorithm model of the present disclosure.

On the other hand, as another method for calculating the lower leg bisection line that may be used in the present disclosure, the point that bisects the distance between the coordinate values of the inner ankle and the outer ankle may be set as the center point of the ankle, and the center point of the ankle is set as the center, and a plurality of radii of with predetermined distances about the center point of the ankle are set and may be a linear form close to a vertical line (vertical line) detected using a linear regression method and a least squares approximation method for a center point that bisects both points where the radius and the calf outline meet.

The above-mentioned inclination angle of the inner ankle, the inclination angle of the outer ankle, and the inclination angle of the lower leg bisection line are used as input data of the neural network model of the present disclosure.

In addition, left and right area data of the heel of the foot may be further included as the input data of the neural network model of the present disclosure. The left and right area data of the heel of the foot refers to the ratio of the area in which the heel portion is divided left and right by the lower leg bisection line.

The foot analysis processor 220 includes a foot type determination unit 224 that derives the foot type using a series of neural networks from input data.

A deep neural network (DNN) is an artificial neural network configured of multiple hidden networks between the input layer and the output layer. As the number of hidden layers increases, the artificial neural network deepens, and is useful for classifying input data, interpreting clusters, and recognizing specific patterns in data. Among the input data, numerical information, that is, the inclination angle of the ankle, the inclination angle of the lower leg bisection line, and the ratio of left and right areas of the heel may be obtained through the deep neural network.

A convolutional neural network (CNN) is a method for more effectively processing two-dimensional data such as images by applying a filtering technology to the artificial neural network. Unlike processing images using fixed filtering technology, the convolutional neural network automatically learns each element of a filter represented by a matrix to be suitable for data processing. The structure of the convolutional neural network is configured such that a filtering technology is applied to the original image by adding a new layer called a convolutional layer and a pooling layer before a fully-connected layer, and then a classification operation is performed on the filtered image. Among the input data, the foot image from which the background is removed is obtained through a convolutional neural network, and after being digitized through a probability calculation function such as a softmax function, the deep neural network may be achieved by combining the hidden layer of the deep neural network of the inclination angle of the ankle, the inclination angle of the lower leg bisection line, and the ratio of left and right areas of the heel of the foot. At the beginning of learning, the result (foot type) output by the foot analysis processor 220 shows a large error value (high loss) compared to the result (foot type) classified by the expert, but through repeated learning, gradually converges (foot type matching) on the foot type classified by the expert, and thereby the neural network algorithm of the present disclosure is established.

The foot analysis processor 220 includes an insole selection unit 225 that derives the foot type using a series of neural networks from foot type input data.

Among the eight types described above according to the learning model of the present disclosure, if A-type (S+++), B-type (P+), C-type (P), D-type (P++), E-type (S++), and E-type (P+++) are derived, customized insole information optimized for each foot type is selected and transmitted to the customer.

The customized insole according to the present disclosure may provide a form optimized for the customer's feet according to the foot type through the height and inclination of the inside (inward) and outside (outward) of the forefoot (FF), midfoot (MF), and rearfoot (RF). As a material of the insole according to the present disclosure, materials known as insole materials may be used. Synthetic resin may be used for the entire skeleton of the insole of the present disclosure, and as an example, ethylene-vinyl acetate copolymer (EVA), polyurethane, and latex may be used, and foamed products thereof may be used, but are not limited thereto.

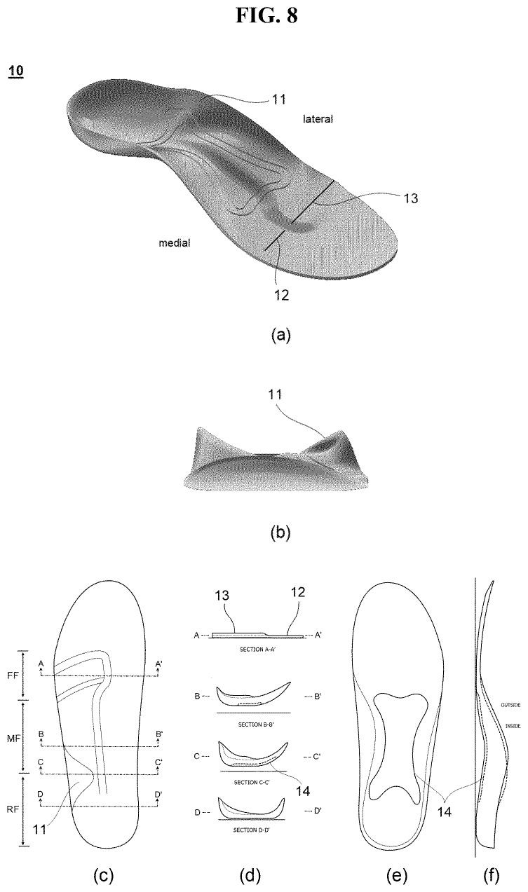

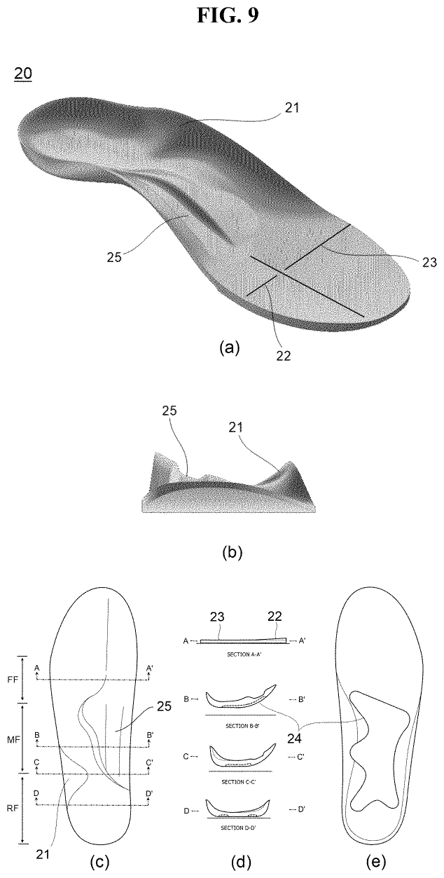

First, the A-type is overall level 3 supinated type and corresponds to severe cavus. 8 shows an example of a preferred insole (A-type insole) applied to the A-type of the present disclosure. Referring to FIG. 8, in the G-type insole 10, in order to control strong rearfoot varus, the rearfoot RF of the insole is formed higher on the lateral side than on the medial side and has an inclined shape. In one aspect, the inclination angle may be an inclination angle of 5 to 15 degrees. Since the level 3 supinated foot has a shape of leaning outward as a whole, the midfoot of the A-type insole 10 is also formed relatively higher on the lateral side than on the medial side. In addition, in order to reduce the inversion of the foot leaning outward, a cacaneual cuboid arch (hereinafter referred to as “CCA”) support portion 11 for accommodating the CCA may be further formed at a portion of the insole 10 corresponding to the CCA that is a portion where the calcaneus of the rearfoot (RF) and the cuboid of the midfoot (MF) are combined. The CCA support portion 11 is preferably a relatively high level 3 support portion, but a level 2 or level 1 CCA support portion is also possible. In the A-type foot, since the little toe is lifted higher than the big toe or the big toe is pressed down, the first calcaneal head accommodation portion 12 in the forefoot (FF) of the insole may be formed lower than the second, third, fourth, and fifth calcaneal head accommodation portions 13 (reverse mortions extension). On the other hand, in the A-type insole, if necessary, a shank 14 may be provided at the lower center of the insole to firmly support the center of the arch of the foot. A material of the shank is a hard material and may be a polymer resin such as polypropylene or polyethylene, but is not limited thereto.

The B-type is an eversion type foot in which the instep is low, the arch of the foot is low, and the foot leans inward, and it corresponds to a clinically mild foot. FIG. 9 shows an example of a preferred insole (B-type insole) applied to the B-type of the present disclosure. Referring to FIG. 9, the rearfoot of the insole of the B-type 20 is formed of a gentle inclination higher on the inner side than on the outer side in order to prevent the foot from leaning inward (eversion). The forefoot is formed higher on the inner side 22 than on the outer side 23, the big toe portion is formed higher by extending from the first calcaneal head (mortons extension), and the outer CCA portion may be formed of a relatively low support portion of level 1. On the other hand, in the B-type insole, if necessary, a shank 24 may be provided at the lower center of the insole to firmly support the center of the arch of the foot. If necessary, a plantar fascia groove 25 for accommodating the inner plantar fascia may be further formed in the midfoot to prevent excessive tension in the inner plantar fascia from occurring.

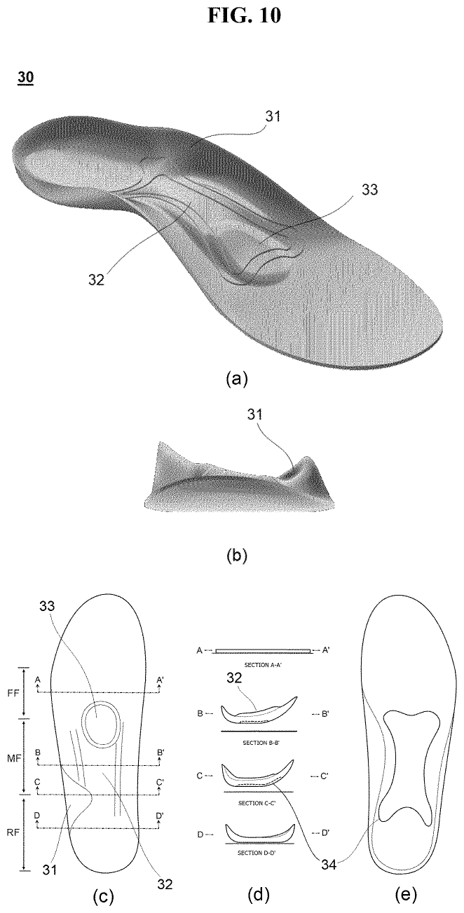

The C-type corresponds to a foot type in which the instep is low and the arch of the foot is low, but the foot is generally not biased in any direction. 10 shows an example of a preferred insole (C-type insole) applied to the C-type of the present disclosure. Referring to FIG. 10, the rearfoot of the C-type insole 30 is formed slightly higher on the inner side than on the outer side with a flat or gentle inclination without inclination, and the midfoot is formed of a support portion 32 protruding to control the transverse arch, the center of the forefoot is formed of a protruding support portion 33 for accommodating the third calcaneal head, and the CCA portion may be formed of a level 1 low CCA support portion 31. On the other hand, in the C-type insole, if necessary, the shank 34 may be provided at the lower center of the insole to firmly support the center of the arch of the foot.

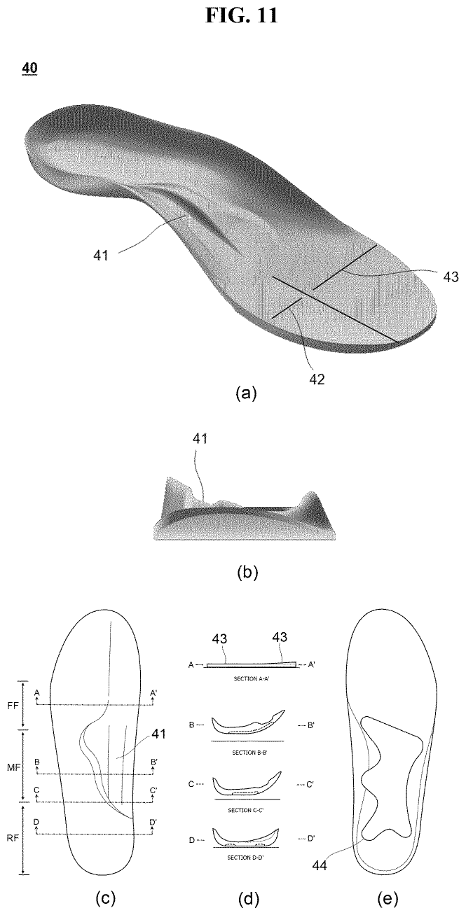

The D-type is the eversion type foot in which the instep is low, the arch of the foot is low, and the foot leans inward, and corresponds to clinically a moderate foot. FIG. 11 shows an example of a preferred insole (D-type insole) applied to the D-type of the present disclosure. Referring to FIG. 11, the rearfoot of the D-type insole 40 is formed higher on the inside than on the outside with a gentle inclination to prevent the foot from leaning inward (eversion), and the forefoot is formed slightly higher on the inside 42 than on the outside 43, the big toe portion may be formed slightly high by extending (mortons extension) from the first calcaneal head. On the other hand, in the D-type insole, if necessary, a shank 44 may be provided at the lower center of the insole to firmly support the center of the arch of the foot. If necessary, a plantar fascia groove 41 for accommodating the inner plantar fascia may be further formed in the midfoot to prevent excessive tension in the inner plantar fascia from occurring.

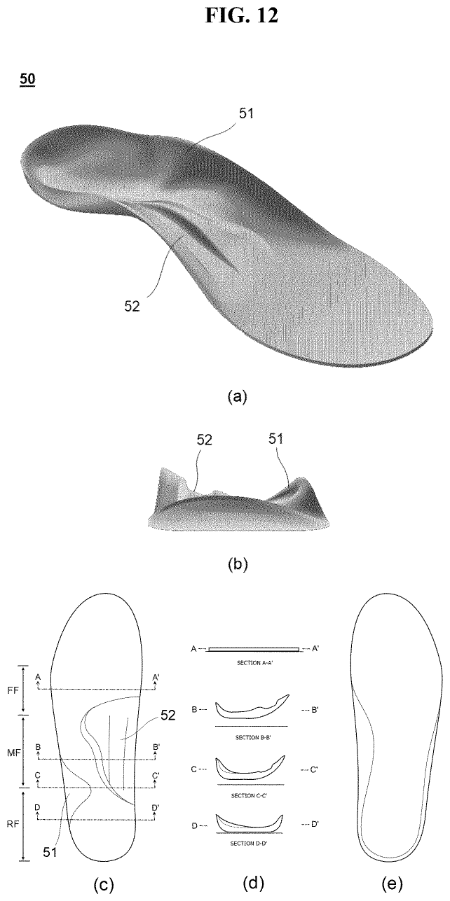

The E-type is the inversion type foot in which the instep is high, the arch of the foot is high, and the foot leans outward, and corresponds to clinically less severe than the A-type. FIG. 12 shows an example of a preferred insole (E-type insole) applied to the E-type of the present disclosure. Referring to FIG. 12, the rearfoot of the E-type insole 50 is formed higher on the inside (medial) than on the outside (lateral) with an inclination angle of 2 to 10 degrees, and the forefoot is formed slightly higher on inside 42 than on outside 43, and the CCA portion may be formed of a two-level CCA support 51. On the other hand, in the E-type insole, if necessary, a shank may be further provided at the lower center of the insole to firmly support the center of the arch of the foot. If necessary, a plantar fascia groove 52 for accommodating the inner plantar fascia may be further formed in the midfoot to prevent excessive tension in the inner plantar fascia from occurring.

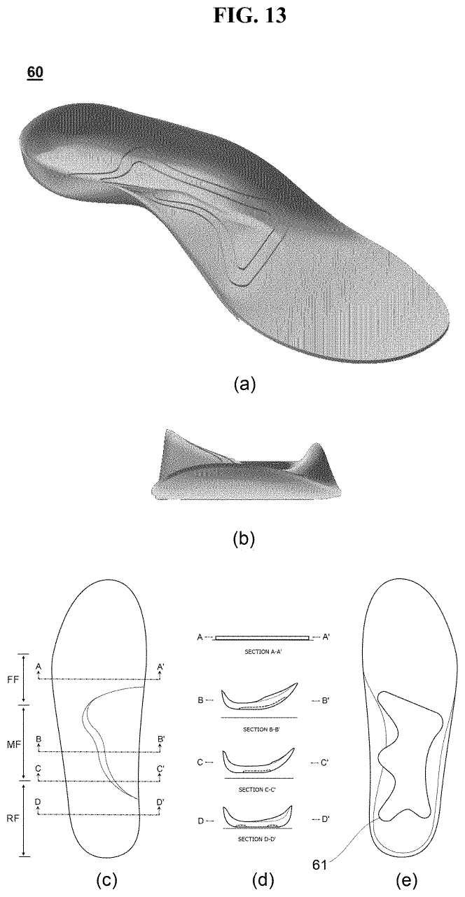

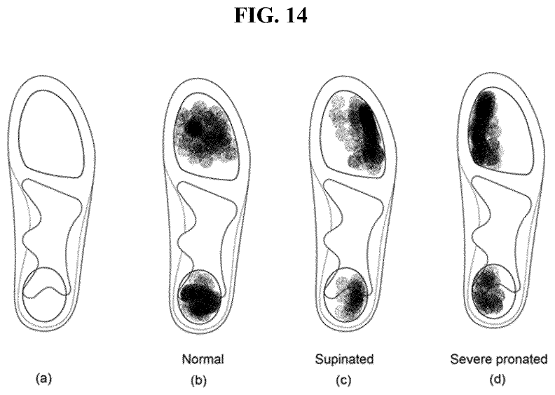

The F-type foot is the eversion foot type in which the instep is low, the arch of the foot is low, and the foot leans inward, and corresponds to clinically severe flat feet. FIG. 13 shows an example of a preferred insole (F-type insole) applied to the F-type of the present disclosure. Referring to FIG. 13, the rearfoot of the F-type insole 60 is formed of higher inclination on the inside than on the outside to prevent the foot from leaning inward (eversion), and the midfoot may be formed sufficiently higher on the outside than the inside to increase the arc. On the other hand, in the F-type insole, if necessary, a shank 34 may be provided at the lower center of the insole to firmly support the center of the arch of the foot.

On the other hand, in one aspect, the above-described insoles of the present disclosure may have a pressure sensitive film attached to a lower surface or an upper surface thereof. The pressure sensitive film is a film in which color development occurs in the corresponding portion by the pressure applied to the film surface, and the pressure distribution according to whether the color development occurs and the intensity of color development may be visually confirmed. The pressure sensitive film has a structure formed of a microcapsule layer filled with a color former on a film substrate such as PET, and a color developer layer, and has a structure in which the color former and color developer are separated by the microcapsule film below a critical pressure, and then the microcapsule is broken by the pressure above the critical pressure, and the color former and developer react chemically with each other to develop color. The microcapsule film may be configured of, for example, a polymer resin such as polyurea resin or polyurethane resin, and the critical pressure may be increased or decreased by adjusting the thickness of the microcapsule film.

The pressure sensitive film may be in an attached state to the insole or is attached to the insole by the customer after being delivered to the customer in an unattached state. The pressure sensitive film may, for example, be attached to the entire size of the insole as a single film, or may be separately attached to the forefoot and rearfoot of the insole, that is, in the form of two films, as shown in FIG. 14.

After purchasing the insole of the present disclosure, the customer inserts the insole with the pressure sensitive film attached, into the shoe, walks for a certain period of time, obtains a colored pressure sensitive film or insole image (photo), and then transmits it to the customer server 200 through the customer terminal.

The supplier server 200 determines whether the ordered insole conforms to the foot type of the customer by analyzing the color displayed on the pressure sensitive film and evaluating the pressure distribution.

FIG. 14 is an insole with the pressure sensitive film attached according to an example of the present disclosure, which shows (a) pressure sensitive film attached, (b) normal, (c) abnormal as the supinated state, (d) abnormal as the pronated state.

For example, when the pressure distribution is formed at the center of the forefoot and rearfoot of the insole (FIG. 14(b)), it may be determined that the ordered insole conforms to the customer's foot type in the normal range, and as in FIGS. 14(c) and (d), when the pressure distribution is biased to one side of the insole, it may be determined that the ordered insole does not conform to the customer's foot type in an abnormal range. In one aspect, the conformity determination of the pressure sensitive films may be made by a pressure sensitive film analysis unit or an analysis algorithm provided in the supplier server. In another aspect, the conformity determination of the pressure sensitive film may be made by a podiatrist's visual observation.

The present disclosure relates to a method for ordering customized insole using an artificial intelligence (AI) algorithm, and more particularly, to a method for ordering insole optimized to a customer in which a learning model classifying foot types from various human foot images is established by using an artificial intelligence algorithm, an image of a customer's rearfoot is read based on the learned model, and customized insole information corresponding to the foot type is provided to the customer.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for ordering customized insole using an artificial intelligence algorithm, comprising:
(a) a step of acquiring a plurality of rearfoot original images to build a learning model using an artificial intelligence algorithm;
(b) a step of detecting a rearfoot image where background and/or noise are removed from the obtained original rearfoot image;
(c) a step of calculating an inclination angle of the inner ankle, an inclination angle of the outer ankle, and an inclination angle of the lower leg bisection line from the detected rearfoot image data and the detected rearfoot image, and generating them as input data (input layer) of the learning model;
(d) a step of performing foot type learning for learning the input data (input layer) as output data (output layer) of the foot type using the artificial intelligence algorithm;
(e) a step of classifying the foot type for classifying the customer's foot type by analyzing the foot image transmitted from a customer terminal based on the artificial intelligence algorithm built in the foot type learning step;
(f) a step of transmitting insole information optimized for the classified foot type to the customer terminal; and
(g) a step of outputting order information from the customer terminal to a supplier terminal.

2. The method for ordering customized insole using an artificial intelligence algorithm according to claim 1,
wherein in the step (c), left and right area data of the heel divided to left and right by the lower leg bisection line is further included as the input data of the learning model.

3. The method for ordering customized insole using an artificial intelligence algorithm according to claim 1,
wherein the artificial intelligence algorithm includes a deep neural network and a convolutional neural network,
an inclination angle of the inner ankle, an inclination angle of the outer ankle, and an inclination angle of the lower leg bisection line are learned using a deep neural network, and
the rearfoot image is learned using a convolutional neural network.

4. The method for ordering customized insole using an artificial intelligence algorithm according to claim 1,
wherein an angle of the inner ankle is an angle of a straight line created by connecting the inner ankle calculated from the rearfoot image and an inner surface of the foot sole, and
an angle of the outer ankle is an angle of a straight line created by connecting the outer ankle calculated from the rearfoot image and an outer surface of the foot sole.

5. The method for ordering customized insole using an artificial intelligence algorithm according to claim 1,
wherein an inclination angle of the lower leg bisection line is an angle of a vertical line detected by setting a series of center points from coordinates on both sides where a plurality of horizontal lines (transverse lines) created by multi-dividing a portion corresponding to the lower leg (calf) in the lower leg (calf) foot image by certain heights, and using a linear regression method and a least squares approximation method for the center points.

6. The method for ordering customized insole using an artificial intelligence algorithm according to claim 1,
wherein the foot type includes the following six types,
\textcircled{1} A-type: overall level 3 supinated type which is an uncompensated rearfoot varus and in which the forefoot is the highest level 3 forefoot valgus, and an arch height is level 3;
\textcircled{2} B-type: overall level 1 pronated type in which the rearfoot is rearfoot valgus, the forefoot is flexible forefoot valgus, and the arch height is level 1;
\textcircled{3} C-type: overall neutral (normal) type (P) in which the rearfoot is uncompensated varus, the forefoot is neutral, and the arch height is intermediate level 2;
\textcircled{4} D-type: overall level 2 pronated type in which the rearfoot is compensated varus, the forefoot is neutral, and the arch height is level 1;
\textcircled{5} E-type: overall level 2 supinated type in which the rearfoot is uncompensated varus, the forefoot is level 2 varus, and the arch height is level 2; and
\textcircled{6} F-type: overall level 3 pronated type in which the rearfoot is compensated rearfoot varus, the forefoot is varus, and the arch height is 0-level.

7. The method for ordering customized insole using an artificial intelligence algorithm according to claim 6,
wherein the rearfoot of the insole applied to the A-type is formed higher on the lateral side than on the medial side by an inclination angle of 5 to 15 degrees,
in the forefoot, the second, third, fourth, and fifth calcaneal head receiving portions are formed higher than the first calcaneal head receiving portion,
the midfoot is formed higher on the lateral side than on the medial side, and
a calcaneus cuboid arch portion where the calcaneus and cuboid are combined is formed of a level 3 high support portion.

8. The method for ordering customized insole using an artificial intelligence algorithm according to claim 6,
wherein the rearfoot of the insole applied to the B-type is formed higher on medial side than on the lateral side with a gentle inclination to prevent the foot from leaning inward (eversion),
the forefoot is formed higher on the medial side than on the lateral side,
the big toe portion extends from the first calcaneal head (mortons extension) and is formed slightly high, and
the lateral calcaneus cuboid arch portion is formed of a level 1 low support portion.

9. The method for ordering customized insole using an artificial intelligence algorithm according to claim 6,
wherein the rearfoot of the insole applied to the C-type is formed slightly higher on the medial side than on the lateral side with no inclination or a gentle inclination,
the midfoot is formed of a support portion to control the transverse arch,
in the forefoot, the second, third, and fourth calcaneal head receiving portions are formed slightly higher than the left and right peripheral portions, and
the lateral calcaneus cuboid arch portion is formed of a level 1 low support portion.

10. The method for ordering customized insole using an artificial intelligence algorithm according to claim 6,
wherein the rearfoot of the insole applied to the D-type is formed higher on the medial side than on lateral side with a gentle inclination to prevent the foot from leaning inward (eversion),
the forefoot is formed higher on the medial side than on the lateral side, and
a big toe portion is formed slightly high by extending from the first calcaneal head (mortons extension).

11. The method for ordering customized insole using an artificial intelligence algorithm according to claim 6,
wherein the rearfoot of the insole applied to the E-type is formed higher on the lateral side than on the medial side at an inclination angle of 2 to 10°,
the forefoot is formed slightly higher on the medial side than on the lateral side, and
the calcaneus cuboid arch portion where the calcaneus and cuboid are combined is formed of a two-level support portion.

12. The method for ordering customized insole using an artificial intelligence algorithm according to claim 6,
wherein the rearfoot of the insole applied to the F-type is formed higher on the medial side than on the lateral side with an inclination to prevent the foot from leaning inward (eversion),
the forefoot is formed higher on the medial side than on the lateral side,
the big toe portion is formed slightly high by extending from the first calcaneal head (mortons extension), and
the lateral calcaneus cuboid arch portion is formed of a level 1 low support portion.

13. The method for ordering customized insole using an artificial intelligence algorithm according to claim 1,
wherein a pressure sensitive film that is colored by a pressure is attached to the lower or upper surface of the insole, so that the pressure distribution applied to the insole when the customer uses the insole is capable of being confirmed.

14. The method for ordering customized insole using an artificial intelligence algorithm according to claim 1,
wherein after step (g), further comprising:
(h) a step of transmitting colored pressure sensitive film image information to the supplier server, reading whether the foot type is suitable, and re-determining the foot type if it is determined to be unsuitable; and
(i) a step of re-learning the foot type using the artificial intelligence algorithm based on the re-determined foot type data.
